(19) United States
(12) Patent Application Publication
(10) Pub. No.: US 2004/0207175 A1
(43) Pub. Date: Oct. 21, 2004

(54) Easy hitch

(76) Inventor: Scott Peter Hamilton, Laguna Beach, CA (US)

Correspondence Address: SCOTT HAMILTON, 21431 STANS LANE, LAGUNA BEACH, CA, 92651, US

(21) Appl. No.: 10/420,411

(22) Filed: Apr. 21, 2003

(51) Int. Cl. B60D 1/00

(52) U.S. Cl. 280/477

(57) ABSTRACT

The Easy Hitch consists of two identical rods 48″ in height which are placed on the ball of towing vehicle and hitch coupler of trailer by magnetic force for aiding a driver to align his towing vehicle hitch to his trailer coupler without the need of another person and eliminating multiple attempts of backing up.

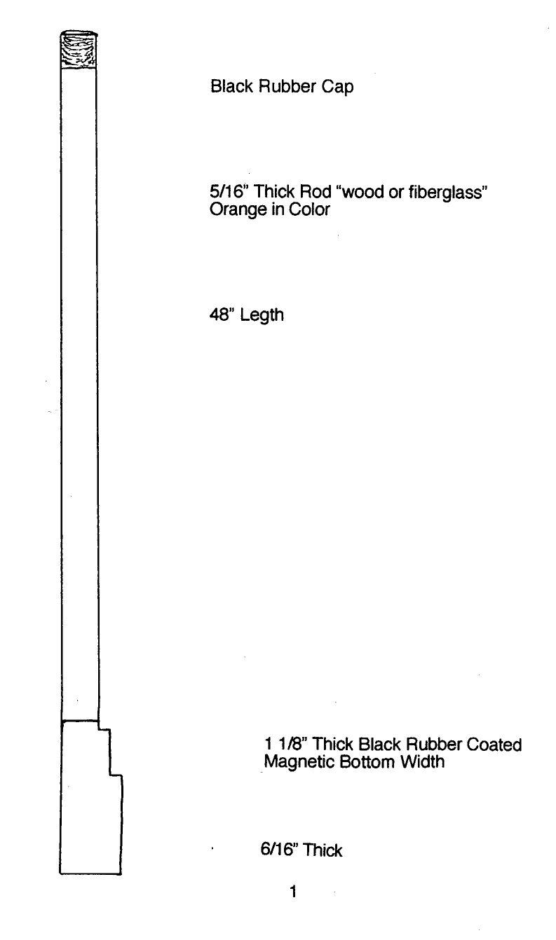

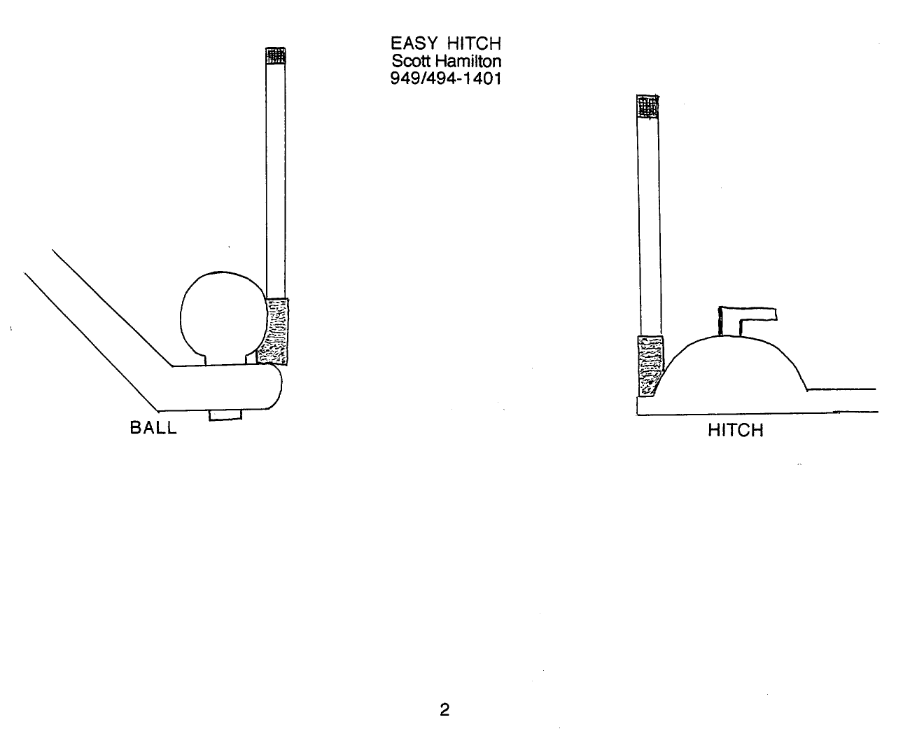

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### BACKGROUND OF THE INVENTION

In attempting to connect a truck hitch ball to a trailer coupler, I found it difficult to align the ball and hitch due to the inability to see without the help of another person. Therefore, I invented the Easy Hitch. This assembly consists of two identical rods in which one is magnetically placed on the ball of your towing vehicle and the other on the front lip of your trailer hitch. You back up your towing vehicle, aligning the rods and when the rod on your truck hitch falls, that indicates that you are perfectly aligned and ready to be connected.

### SUMMARY OF THE INVENTION

In summary, this invention is designed to allow a single person to connect a towing vehicle and a trailer quickly and easily. The Easy Hitch eliminates the need for two people and the multiple attempts of backing up and aligning the hitch and ball. With Easy Hitch, you simply look in your rear view mirror or over your shoulder and slowly back your vehicle up to align the rods. When the rod on your truck ball falls, your hitch and ball are aligned.

### DETAILED DESCRIPTION OF THE INVENTION

The Easy Hitch assembly consists of two identical rods made out of wood or fiberglass. Each rod is 48″ tall×⅜ diameter. Each rod is coated with orange fluorescent paint for easy visibility day or night. At the top of each rod is a black rubber cap and a magnet is attached to the bottom of each rod with a rubber coating.

What I claim as my invention is:

1. This two part assembly consists of two identical rods which are are placed on the hitch of your towing vehicle and ball of your trailer and are secured by magnetic force. The driver simply looks in his or her rear view mirror or over his or her shoulder and slowly backs up his towing vehicle and aligns the rods without the assistance of another person and eliminating multiple attempts to align hitch and coupler.
